(19) United States
(12) Patent Application Publication
(10) Pub. No.: US 2011/0305487 A1
(43) Pub. Date: Dec. 15, 2011

(54) INTERMEDIATE TRANSFER BELT AND IMAGE-FORMING APPARATUS

(75) Inventor: Yohei NAKADE, Okazaki-shi (JP)

(73) Assignee: Konica Minolta Business Technologies, Inc., Tokyo (JP)

(21) Appl. No.: 13/157,037

(22) Filed: Jun. 9, 2011

(30) Foreign Application Priority Data
Jun. 14, 2010 (JP) 2010-135167

(51) Int. Cl. G03G 15/14

(52) U.S. Cl. 399/308

(57) ABSTRACT

An intermediate transfer belt has an elastic layer and a modified layer formed by a surface-modifying treatment of a surface of the elastic layer, wherein the surface of the elastic layer with the modified layer has a surface hardness of 0.01 GPa or more and exhibits 50 nm or more of displacement at the time of pushing the surface at a load of 20 μN by means of a cube corner tip having a tip sharp angle of 90 degree.

This application is based on the patent application No. 2010-135167 filed in Japan, the contents of which are hereby incorporated by reference.

### BACKGROUND OF THE INVENTION

1. Field of the Invention

The present invention relates to an intermediate transfer belt that is used for primarily transferring a toner image formed on a surface of a photosensitive member in an image-forming apparatus by use of an electrophotographic method, such as a copying machine, a facsimile and a laser printer, and to an image-forming apparatus equipped with said intermediate transfer belt.

2. Description of the Related Art

A conventional intermediate transfer belt generally has a structure comprising an elastic layer and a surface layer (covering layer) which is separately formed on the surface of the elastic layer. The elastic layer exhibits good transferring properties for a paper having concavities and convexities. The surface layer exhibits excellent transferring properties (releasing properties) for a toner. In particular, it is desired that the surface layer is formed from a material having an excellent wear resistance in order to maintain the transferring properties for a long period. The surface layer is formed from an organic material or an inorganic material (Japanese Patent Application Laid-Open No. Hei 11-84901).

However, the material having an excellent wear resistance is generally hard as a material for forming the surface layer. If the surface layer made of such a material is formed on the elastic layer, an inherent flexibility of the elastic intermediate transfer belt is impaired and, as a result, an image density is lowered and an image-loss phenomenon occurs on an image. The image-loss phenomenon refers to a phenomenon wherein a high pressure is applied to an image when the image formed on the intermediate transfer belt is secondarily transferred onto a recording material and, the toner is subjected to a stress deformation, so that an aggregating force among the toner particles increases, and a part of an image is remained on the intermediate transfer belt without being transferred.

When the inherent flexibility of the elastic intermediate transfer belt is prior to the wear resistance, it is necessary to use a flexible material as the material for forming the surface layer or to thin the thickness of the surface layer. Therefore, when the elastic intermediate transfer belt having the flexible surface layer is used for a long period, the surface of the belt is worn and the belt does not exhibit the initial functions. As a result, the image density is lowered and the image-loss phenomenon occurs on an image.

### BRIEF SUMMARY OF THE INVENTION

The present invention relates to an intermediate transfer belt comprising an elastic layer and a modified layer formed by a surface-modifying treatment of a surface of the elastic layer,

wherein the surface of the elastic layer with the modified layer has a surface hardness of 0.01 GPa or more and exhibits a displacement of 50 nm or more at the time of pushing the surface at a load of 20 μN by means of a cube corner tip having a tip sharp angle of 90 degree.

### BRIEF DESCRIPTION OF THE DRAWINGS

FIG. 1(A) is a schematic cross-sectional view showing one example of the intermediate transfer belt according to the present invention, and FIG. 1(B) is a schematic cross-sectional view showing another example of the intermediate transfer belt according to the present invention.

FIG. 2 is a schematic structural view showing one example of the image-forming apparatus according to the present invention.

### DETAILED DESCRIPTION OF THE INVENTION

An object of the present invention is to provide an intermediate transfer belt that can maintain initial excellent flexibility and transferring properties even in the case of endurance of printing operations, and sufficiently suppress a deterioration of an image density and an occurrence of an image-loss phenomenon for a long period, and an image-forming apparatus equipped with said intermediate transfer belt.

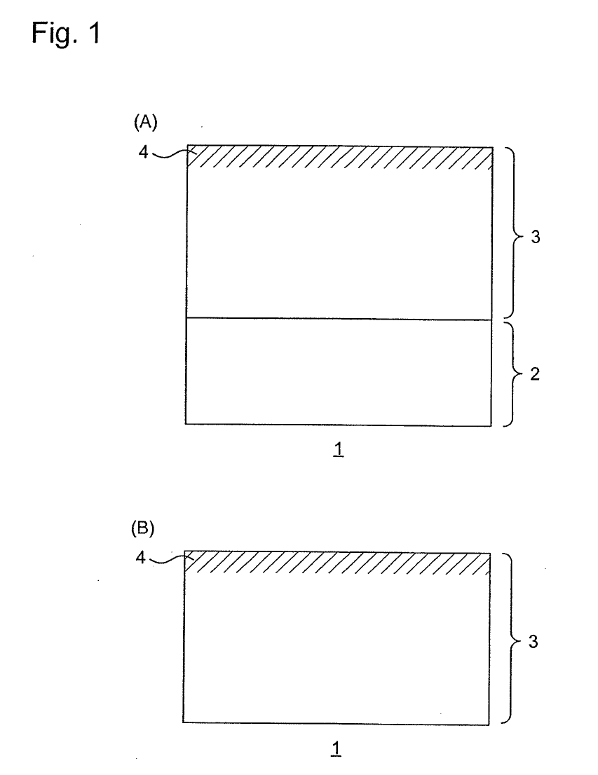

An intermediate transfer belt according to the present invention has an elastic layer on its surface and the surface of the elastic layer exhibits specified characteristic values. The intermediate transfer belt according to the present invention may further have other layers, for example, a so-called base layer or may have an adhesive layer between the base layer and the elastic layer. More specifically, an intermediate transfer belt 1 according to the present invention may have a structure in which an elastic layer 3 is formed on a base layer 2, as shown in FIG. 1(A), or may have a structure in which only the elastic layer 3 is formed without forming the base layer, as shown in FIG. 1(B).

Elastic Layer

The surface of the elastic layer 3 is subjected to a surface-modifying treatment in the present invention, that is, a surface layer portion of the elastic layer 3 is modified by means of the surface-modifying treatment in order to form a modified layer 4. Accordingly, even if a surface layer comprising an organic material or an inorganic material is not formed on the elastic layer, excellent transferring properties can be obtained for a long period, and sticky properties of the surface of the elastic layer can be decreased without deteriorating the flexibility of the intermediate transfer belt.

The surface of the elastic layer 3, that is, the surface of the modified layer 4 in the elastic layer 3 specifically has a surface hardness of 0.01 GPa or more, in particular 0.01 to 0.80 GPa, preferably 0.01 to 0.20 GPa. If the surface hardness is too small due to a low degree of modification, the transferring properties are deteriorated and the image density is decreased since the surface-modifying treatment is not sufficient.

The surface hardness can be controlled by adjusting treatment conditions for the surface-modifying treatment which will specifically be described below. For example, when the treatment conditions, such as a contact time with a treatment liquid (an immersion time), a treatment temperature, a concentration of the treatment liquid and the like, are increased, the surface hardness becomes high. On the other hand, when such treatment conditions are decreased, the surface hardness becomes low.

The surface hardness described in the present specification is an average value of three measured values obtained at three arbitrary points by means of a nano-indentation method. A TRIBOINDENTER made by HYSITRON Corporation is used as a measuring device, and a cube corner tip (also referred to as a cube corner indenter) (having a tip sharp angle of 90 degree) is used as a tip indenter in order to perform the measurement. Specifically, according to the description of Handbook of Micro/Nano Tribology (Bharat Bhushman edit, CRC), the indenter was applied to the surface of a sample at a right angle, a load was gradually applied thereto and, after the load was reached to the maximum load, the load was gradually returned to 0.

The surface of the elastic layer 3, that is, the surface of the modified layer 4 in the elastic layer 3 exhibits a displacement of from 50 nm or more, preferably from 50 to 80 nm at the time of pushing the surface at a load of 20 μN. If the displacement is too small due to too high degree of modification, the flexibility and the transferring properties are deteriorated, and the image-loss phenomenon occurs.

Such a displacement can be controlled by adjusting the thickness of the elastic layer and the treatment conditions for the surface-modifying treatment which will specifically be described below. For example, when the thickness of the elastic layer is thinned or when the treatment conditions, such as a heating time, a treatment temperature, a concentration of a treatment liquid and the like, are increased, the displacement becomes small. On the other hand, when the thickness of the elastic layer is thickened or when such treatment conditions are decreased, the displacement becomes large.

The displacement at the time of pushing the surface at a load of 20 μN is an average value of three measured values obtained at three arbitrary points by using the same measuring method as that of the surface hardness mentioned above, except that the maximum load is set to 20 μN and the displacement is measured.

The lower limit of “0.01 GPa” in the surface hardness of the modified layer 4 mentioned above shows a critical value for a soft modified layer. The lower limit of “50 nm” in the displacement at the time of pushing the surface at a load of 20 μN shows a critical value for a hard modified layer. Since the modified layer 4 exists in an area having a slightly small thickness in the surface of the elastic layer 3, an application of very small stress to the surface and a detection of very small displacement of the surface would be necessary for measuring the hardness of the modified layer. Accordingly, as a result of a more precise measurement, it is confirmed that a measuring method of the critical value for the soft modified layer differs from that for the hard modified layer.

The thickness of the elastic layer 3 comprising the modified layer 4 is normally set in the range of from 100 to 500 μm, preferably, from 200 to 300 μm.

The modified layer 4 can be formed by forming the elastic layer 3 and then performing a surface-modifying treatment on the surface of the elastic layer.

The elastic layer is an organic compound layer having elasticity. As the elastic material forming the elastic layer (elastic material rubbers, elastomers), one kind or two or more kinds of materials selected from the following group may be used. The group consists of butyl rubber, fluorine-based rubber, acryl rubber, ethylene-propylene rubber (EPDM), nitrile-butadiene rubber (NBR), acrylonitrile-butadiene-styrene rubber, natural rubber, isoprene rubber, styrene-butadiene rubber, butadiene rubber, ethylene-propylene rubber, ethylene-propylene ter-polymer, chloroprene rubber, chlorosulfonated polyethylene, chlorinated polyethylene, urethane rubber, syndiotactic 1,2-polybutadiene, epichlorohydrin-based rubber, silicone rubber, fluorine rubber, polysulfide rubber, polynorbornane rubber, hydrogenated nitrile rubber, and thermoplastic elastomer (for example, polystyrene-based, polyolefin-based, polyvinyl chloride-based, polyurethane-based, polyamide-based, polyurea-based, polyester-based and fluorine resin-based elastomers). The elastic material which constitutes the elastic layer is preferably NBR. However, needless to say, the present invention is not limited thereto.

A resistance-value adjusting conductive agent may be added to the elastic layer. Although not particularly limited, examples of the resistance-value adjusting conductive agent include: carbon black, graphite, metal powder, such as aluminum and nickel, and conductive metal oxides, such as tin oxide, titanium oxide, antimony oxide, indium oxide, potassium titanate, antimony oxide-tin oxide composite oxide (ATO) and indium oxide-tin oxide composite oxide (ITO). The conductive metal oxide may be coated with insulating fine particles, such as barium sulfate, magnesium silicate and calcium carbonate. The present invention is not limited to the above-mentioned conductive agents.

The content of the conductive agent in the elastic layer is set in the range of, preferably from 0.1 to 30 parts by weight, more preferably from 1 to 30 parts by weight relative to 100 parts by weight of the elastic material.

As the surface-modifying treatment for forming the modified layer 4, an isocyanate treatment can be used in the present invention.

The surface treatment can be performed by impregnating an isocyanate compound into a surface of the elastic layer and then performing a heating treatment. That is, the surface treatment can be performed by impregnating the isocyanate compound into an outer circumferential face of the elastic layer and then reacting the isocyanate compound on said face by the heating treatment. Although heating temperature and time for the reaction depend on an impregnated amount of the isocyanate, the heating temperature may be set in the range from 80 to 200° C., and the heating time may be set in the range from 30 minutes to 12 hours. When the isocyanate compound is impregnated into the outer circumferential face of the elastic layer, a method can be adopted, wherein a solution of the isocyanate compound is contacted with the surface of the elastic layer to impregnate said solution into said surface. The impregnated amount of the isocyanate can be adjusted by the contact time of said solution.

Examples of the isocyanate compound include aromatic isocyanates, aliphatic isocyanates and the like. Specific examples of the isocyanate compound include toluene diisocyanate (TDI), diphenylmethane diisocyanate (MDI), crude MDI and the like. Other compounds may be added to a material for forming the modified layer as long as they do not interfere a reactivity of the isocyanate compound. As a commercially available isocyanate compound, MR 400 (made by NIPPON POLYURETHANE INDUSTRY Co,. Ltd.), CORONATE HX (made by NIPPON POLYURETHANE INDUSTRY Co,. Ltd.), CORONATE L (made by NIPPON POLYURETHANE INDUSTRY Co,. Ltd.) and CORONATE 65 (made by NIPPON POLYURETHANE INDUSTRY Co,. Ltd.) can be used.

More specifically, the surface treatment can be performed, for example, by dissolving MR 400 (made by NIPPON POLYURETHANE INDUSTRY Co,. Ltd.) comprising MDI as the isocyanate compound in ethyl acetate in order to prepare a treatment solution, contacting said solution with the surface of the elastic layer to impregnate said solution into said surface and heating the elastic layer impregnated with said solution.

Base Layer

The base layer 2, which may be formed if necessary, is an organic polymer compound layer. A mechanical strength of the whole of a belt can be improved by the base layer 2. Examples of the resin material forming the base layer include polycarbonate, fluorine-based resin (ETFE, PVDF), styrene-based resins (monopolymer or copolymer containing styrene or styrene substitute), such as polystyrene, chloropolystyrene, poly-α-methylstyrene, styrene-butadiene copolymer, styrene-vinyl chloride copolymer, styrene-vinyl acetate copolymer, styrene-maleic acid copolymer, styrene-acrylic acid ester copolymer (such as styrene-methylacrylate copolymer, styrene-ethylacrylate copolymer, styrene-butylacrylate copolymer, styrene-octylacrylate copolymer and styrene-phenylacrylate copolymer), styrene-methacrylic acid ester copolymer (such as styrene-methylmethacrylate copolymer, styrene-ethylmethacrylate copolymer and styrene-phenylmethacrylate copolymer), styrene-α-chloromethylacrylate copolymer and styrene-acrylonitrile-acrylate copolymer, methylmethacrylate resin, butylmethacrylate resin, ethylacrylate resin, butylacrylate resin, modified acrylic resin (such as silicone-modified acrylic resin, vinyl chloride resin-modified acrylic resin and acryl-urethane resin), vinyl chloride resin, styrene-vinyl acetate copolymer, vinyl chloride-vinyl acetate copolymer, rosin-modified maleic acid resin, phenolic resin, epoxy resin, polyester resin, polyesterpolyurethane resin, polyethylene, polypropylene, polybutadiene, polyvinylidene chloride, ionomer resin, polyurethane resin, silicone resin, ketone resin, ethylene-ethylacrylate copolymer, xylene resin, polyvinyl butyral resin, polyamide resin, polyimide resin, modified polyphenylene oxide resin, modified polycarbonate, and their mixture.

A resistance-value adjusting conductive agent may be added to the base layer 2. As the resistance-value adjusting conductive agent, the same materials as those resistance-value adjusting conductive agents to be added to the elastic layer may be used.

The content of the conductive agent in the base layer is set in the range of, preferably from 0.1 to 20 parts by weight, more preferably from 1 to 15 parts by weight relative to 100 parts by weight of the resin material.

Although not particularly limited as long as the objective of the present invention is achieved, the thickness of the base layer 2 is normally set in the range of from 50 to 200 μm, preferably, from 80 to 120 μm.

The intermediate transfer belt according to the present invention can be produced by forming the elastic layer 3 and the optional base layer 2, and then performing the aforesaid surface-modifying treatment on the surface of the elastic layer.

As the method for forming the elastic layer 3 and the base layer 2, the following methods are exemplified: a method in which a film as the base and a rubber sheet as the elastic layer are wound around a shaft member made of metal and heating the wound materials under pressure to form an elastic belt wherein the base and the elastic layer are laminated, a centrifugal molding method in which a material is poured into a rotating cylinder-shaped mold to form a belt-shaped layer, a coating method in which a material is spray-coated or dip-coated so as to form a layer, and an injection method in which a material is injected into a gap between an inner mold and an outer mold to form a belt-shaped layer. Upon forming the elastic layer, curing and drying processes are carried out by heating, if necessary. Upon forming the base layer, a drying process is carried out by heating, if necessary.

In the case where an intermediate transfer belt having a structure shown in FIG. 1(A) is manufactured, the order of the formations of the elastic layer 3 and the base layer 2 is not particularly limited, and, for example, after preliminarily forming the elastic layer by the centrifugal molding method, the base layer may be formed by the centrifugal molding method or the coating method. Thereafter, the above-mentioned surface-modifying treatment should be performed on the surface of the elastic layer.

For example, after preliminarily forming the base layer by using the centrifugal molding method, the elastic layer may be formed by the centrifugal molding method or the coating method. Thereafter, the above-mentioned surface-modifying treatment should be performed on the surface of the elastic layer.

For example, after forming the elastic layer by using the injection mold method, the base layer may be formed by using the coating method. Thereafter, the above-mentioned surface-modifying treatment should be performed on the surface of the elastic layer.

For example, after forming the base layer by using the injection mold method, the elastic layer may be formed by using the coating method. Thereafter, the above-mentioned surface-modifying treatment should be performed on the surface of the elastic layer.

In the case where an intermediate transfer belt having a structure shown in FIG. 1(B) is manufactured, the elastic layer 3 may be formed, for example, by the centrifugal molding method or the injection method. Thereafter, the above-mentioned surface-modifying treatment should be performed on the surface of the elastic layer.

Image-Forming Apparatus

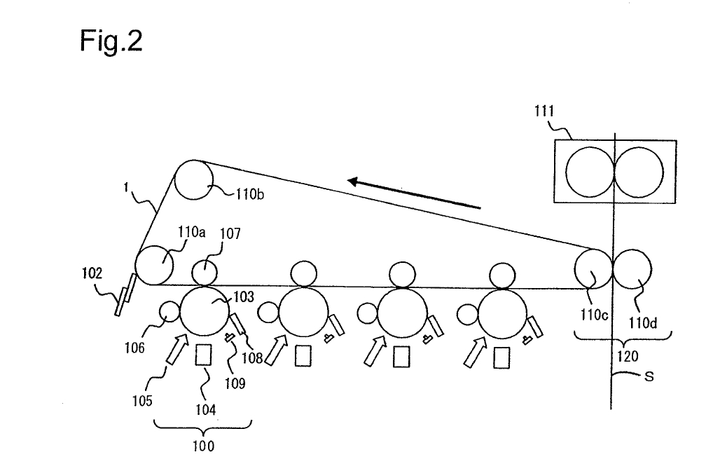

The intermediate transfer belt according to the present invention is used for an image-forming apparatus based upon an electrophotographic system, such as a copying machine, a facsimile and a laser printer, and when a toner image, formed on the surface of a photosensitive member, is transferred onto a recording material such as paper, the intermediate transfer belt is used for once supporting the toner image on its surface so as to be further transported. FIG. 2 shows one example of an image-forming apparatus in which the intermediate transfer belt of the present invention is used.

FIG. 2 is a schematic structural diagram showing a multi-color image-forming apparatus of a tandem-type that is one embodiment of an image-forming apparatus according to the present invention. In the present embodiment, the intermediate transfer belt of the present invention is represented by reference numeral “1”, and has an endless shape. The intermediate transfer belt 1 is wound around a driving roller 110a, a tension roller 110b and a backup roller 110c as a supporting member. Four image-forming units 100 are disposed in a directly-connected state along the horizontal portion of the intermediate transfer belt 1. These image-forming units 100 have substantially the same structure, but differ from one another in that they respectively form toner images of different colors, that is, yellow (Y) color, magenta (M) color, cyan (C) color and black (K) color.

Firstly, the image-forming units 100 will be described. Each of the image-forming units 100 is provided with an electrophotographic photosensitive member (hereinafter, referred to as “photosensitive drum”) 103 that has a drum shape and serves as an image-supporting member placed so as to rotate. On the periphery of the photosensitive drum 103, processing devices, such as a primary charger 104 serving as a primary charging means, an exposing device 105 serving as an exposing means, a developing device 106 serving as a developing means, a transferring device 107 serving as a primary transferring means and a cleaning device 108 serving as a cleaning means, are installed. The other image-forming units 100 also have the same structure. Specifically, each of the image-forming units 100 has the photosensitive drum 103, the primary charger 104, the exposing device 105, the developing device 106, the transferring roller 107 and the cleaning device 108. The image-forming units 100 differ from one another in that they respectively form toner images of respective yellow, magenta, cyan and black colors. A developing vessel (not shown) is normally placed around the developing device 106 disposed in each of the image-forming units 100, and the respective developing vessels house yellow toner (yellow developer), magenta toner (magenta developer), cyan toner (cyan developer) and black toner (black developer).

Next, the following description will discuss image-forming operations of the image-forming apparatus having the above-mentioned structure. The photosensitive drum 103 is uniformly charged by the primary charger 104, and an image signal derived from a yellow color component of a document sent from the exposing device (electrostatic latent-image forming means) 105 is applied onto the photosensitive drum 103 through a polygon mirror and the like so that an electrostatic latent-image is formed thereon. Next, yellow toner is supplied from the developer 106 so that the electrostatic latent-image is developed as a yellow toner image. This yellow toner image is allowed to reach the primary transferring unit where the photosensitive drum 103 and the intermediate transfer belt 1 are brought into contact with each other, in response to the rotation of the photosensitive drum. In the present example, the transferring roller 107 is disposed in the primary transferring unit as the primary transferring means, and a primary transferring bias voltage is applied thereto. Thus, the yellow toner image on the photosensitive drum 103 is primarily transferred onto the intermediate transfer belt 1. The intermediate transfer belt 1 supporting the yellow toner image is transported to the next image-forming unit 100. A magenta toner image, formed on the photosensitive drum in the image-forming unit 100 by the same method as described above at this point of time, is transferred onto the yellow toner image in the primary transferring unit at which the transferring roller is placed. In the same manner, as the intermediate transfer belt proceeds in a direction indicated by an arrow, a cyan toner image and a black toner image are transferred and superposed on the above-mentioned toner image in the respective primary transferring units where the transferring rollers are placed in the same manner as described above. At this point of time, a recording material, sent from a paper-feeding cassette by paper-feeding roller and other transporting rollers, has reached the secondary transferring unit 120. In the secondary transferring unit 120, the secondary transferring device serving as the secondary transferring means, that is, a secondary transferring roller 110d (secondary transferring means) in the present example, is disposed face to face with the backup roller 110c in a manner so as to sandwich the intermediate transfer belt 1. A transferring bias voltage is applied to the secondary transferring roller 110d so that the above-mentioned toner images having four colors are transferred (secondarily transferred) onto the recording material S. The recording material on which the toner image has been transferred is transported to a fixing unit 111. In the fixing unit, the toner image is fixed on the recording material S by applying heat and pressure thereto. Residual transfer toner on the photosensitive drum 103 that has not been transferred in the primary transferring unit is cleaned by the cleaning device 108. Residual transfer toner on the intermediate transfer belt 1 that has not been transferred in the secondary transferring unit 120 is cleaned by an intermediate transferring member cleaning device 102 serving as an intermediate transferring member cleaning means, and is again supplied to the next image-forming process.

### EXAMPLES

### Example 1

### Production of Film for Base Material

3,3′,4,4′-Biphenyltetracarboxylic acid dianhydride was polycondensed with an equimolar amount of p-phenylenediamine at 18° C. in N-methyl pyrrolidone to obtain a solution of polyamide acid (solid content: 18% by weight). Carbon black (particle diameter of 25 μm, specific surface area of 180 m²/g) whose pH and volatile content were respectively adjusted to 3 and 14% by weight by an oxidation treatment and N-methyl pyrrolidone as a diluent were added to the solution of polyamide acid in an agitator equipped with agitating blade, and the obtained mixture was roughly mixed so that the content of the carbon black became 14% by weight relative to the solid content of said solution. Next, the liquid mixture was poured into a ball mill and sufficiently mixed and dispersed at a temperature of 60° C. or less to obtain a stock solution for base material.

While a molding drum made of metal having an inner diameter of 300 mm and a width of 450 mm, whose inner surface was mirror-finished, was rotated, the above-mentioned stock solution for base of 400 g was supplied to the molding drum, and said stock solution was applied on the molding drum. The rotational velocity of the molding drum accompanying a start of heating was gradually raised, and the rotational velocity was adjusted to 700 rpm at the time when a temperature was reached to 120° C. After the rotational state of 700 rpm at 120° C. was maintained for 120 minutes, the heating was stopped and a cooling to normal temperature was performed while the drum was rotated to obtain a polyimide film comprising a slight amount of N-methyl pyrrolidone.

Next, the above-mentioned polyimide film was fitted onto a mirror-finished cylindrical mold made of metal having an outer diameter of 295 mm and a length of 400 mm. The mold with fitted the film was put into a hot-air drying machine and the temperature of the drying machine was gradually raised. After the temperature was reached to 400° C., the heating was performed at the temperature for 20 minutes to perform a desolvation treatment of the film. Thereafter, a cooling to normal temperature was performed to obtain a film for base material.

Production of Rubber Sheet

Hundred parts of NBR (NIPOL DN202, made by Nippon Zeon Corporation), 5 parts of zinc white No. 1 (made by Sakai Chemical Industry Corporation), 0.5 parts of stearic acid (Lunac S30, made by Kao Corporation), of 30 parts of carbon black (Seest SO, made by Tokai Carbon Corporation), 1.5 parts of Sancelar CZ (Sanshin Chemical Corporation), 1.0 parts of Sancelar TT (Sanshin Chemical Corporation) and 1.0 parts of sulfur were kneaded and the obtained mixture was then molded to a sheet shape in order to produce a rubber sheet which can be used as an elastic layer.

Production of Elastic Belt

The above-mentioned film for base material was wound around a shaft member made of aluminum and the above-mentioned rubber sheet was further wound on an outer circumference of the film for base material. The shaft with the wound film and the sheet was subjected to a heating treatment under pressure (160° C.×60 minutes) to form an elastic belt.

Surface Treatment

Hundred parts by weight of MR 400 (made by NIPPON POLYURETHANE INDUSTRY Co,. Ltd.) was dissolved in 900 parts by weight of ethyl acetate to prepare a surface-treatment liquid. While the temperature of surface-treatment liquid was maintained to 20° C., the above-mentioned elastic belt was immersed therein for 10 seconds. The elastic belt was then heated for 10 hours in an oven whose temperature was maintained to 100° C. in order to obtain an elastic belt whose surface was treated.

### Example 2

An intermediate transfer belt was produced by the same method as that described in Example 1, except that the heating time in the oven for the surface treatment was 5 hours.

### Example 3

An intermediate transfer belt was produced by the same method as that described in Example 1, except that the immersion time for the surface treatment was 30 seconds.

### Example 4

An intermediate transfer belt was produced by the same method as that described in Example 1, except that the immersion time for the surface treatment was 30 seconds, and the heating time in the oven for the surface treatment was 5 hours.

### Comparative Examples 1 to 5

The immersion time and the heating time for the surface treatment were adjusted in order to produce intermediate transfer belts exhibiting the hardness and the displacement shown in Table 1.

Evaluation

Each of the intermediate transfer belts produced as described above was installed in a bizhub C650 made by Konica Minolta Technologies, Inc. After printing operations of 100,000 sheets were carried out by printing an image having a printed ratio of 5% in each color, printing operation of a solid image of cyan color was carried out. The printed image was evaluated on an image density in solid image and an image-loss phenomenon in line-image having a width of 120 μm.

Image Density

A transmission density of the image was measured by using a transmission density measuring machine (TD904; made by Macbeth Corporation).

◯: The transmission density was 0.9 or more;
Δ: The transmission density was within the range of 0.8 or more to less than 0.9; and a problem was raised in practical use;
x: The transmission density was less than 0.8.

Image-Loss

The image was visually evaluated.

◯: No image-loss occurred;
Δ: A slight image-loss occurred; and a problem was raised in practical use;
x: An image-loss occurred.

TABLE 1

| | Hardness | Displacement* | Image | Image- | Overall |
|---|---|---|---|---|---|
| | (GPa) | (nm) | Density | loss | Evaluation |
| Example 1 | 0.01 | 50 | ◯ | ◯ | ◯ |
| Example 2 | 0.01 | 80 | ◯ | ◯ | ◯ |
| Example 3 | 0.02 | 50 | ◯ | ◯ | ◯ |
| Example 4 | 0.02 | 80 | ◯ | ◯ | ◯ |
| Comparative | 0.005 | 10 | X | X | X |
| Example 1 | | | | | |
| Comparative | 0.005 | 50 | X | Δ | X |
| Example 2 | | | | | |
| Comparative | 0.005 | 80 | X | Δ | X |
| Example 3 | | | | | |
| Comparative | 0.01 | 10 | Δ | X | X |
| Example 4 | | | | | |
| Comparative | 0.02 | 10 | Δ | X | X |
| Example 5 | | | | | |

*Displacement at the time of pushing at a load of 20 μN

### EFFECTS OF THE INVENTION

The intermediate transfer belt according to the present invention maintains initial excellent flexibility and transferring properties even in the case of endurance of printing operations, sufficiently suppresses a deterioration of an image density and an occurrence of an image-loss phenomenon for a long period.

What is claimed is:

1. An intermediate transfer belt comprising an elastic layer and a modified layer formed by a surface-modifying treatment of a surface of the elastic layer,
wherein the surface of the elastic layer with the modified layer has a surface hardness of 0.01 GPa or more and exhibits a displacement of 50 nm or more at the time of pushing the surface at a load of 20 μN by means of a cube corner tip having a tip sharp angle of 90 degree.

2. The intermediate transfer belt of claim 1, wherein the surface-modifying treatment is a treatment for chemically bonding an isocyanate compound to the surface of the elastic layer.

3. The intermediate transfer belt of claim 1, wherein the elastic layer has a thickness of 100 μm to 500 μm.

4. The intermediate transfer belt of claim 1, wherein the elastic layer comprises an elastic material and a conductive agent, and the content of the conductive agent is in the range of from 0.1 to 30 parts by weight relative to 100 parts by weight of the elastic material.

5. The intermediate transfer belt of claim 1, having a base layer formed so as to contact with the opposite surface to the modified surface of the elastic layer.

6. The intermediate transfer belt of claim 5, wherein the base layer has a thickness of from 50 μm to 200 μm.

7. The intermediate transfer belt of claim 1, wherein a surface hardness of the modified surface of the elastic layer is from 0.01 to 0.80 GPa.

8. The intermediate transfer belt of claim 1, wherein the elastic layer having the modified surface exhibits a displacement of from 50 nm to 80 nm at the time of pushing the surface at a load of 20 μN by means of a cube corner tip having a tip sharp angle of 90 degree.

9. An image-forming apparatus, comprising:
an intermediate transfer belt according to claim 1,
an image-forming unit for forming a toner image on the intermediate transfer belt; and
an transferring unit for transferring the toner image formed on the intermediate transfer belt onto a sheet.

10. The image-forming apparatus of claim 9, wherein the surface-modifying treatment is a treatment for chemically bonding an isocyanate compound to the surface of the elastic layer.

11. The image-forming apparatus of claim 9, wherein the elastic layer has a thickness of from 100 μm to 500 μm.

12. The image-forming apparatus of claim 9, wherein the elastic layer comprises an elastic material and a conductive agent, and the content of the conductive agent is from 0.1 to 30 parts by weight relative to 100 parts by weight of the elastic material.

13. The image-forming apparatus of claim 9, wherein the intermediate transfer belt has a base layer formed so as to contact with the opposite surface to the modified surface of the elastic layer.

14. The image-forming apparatus of claim 13, wherein the base layer has a thickness of from 50 μm to 200 μm.

15. The image-forming apparatus of claim 9, wherein a surface hardness of the modified surface of the elastic layer is form 0.01 to 0.80 GPa.

16. The image-forming apparatus of claim 9, wherein the elastic layer having the modified surface exhibits a displacement of from 50 nm to 80 nm at the time of pushing the surface at a load of 20 μN by means of a cube corner tip having a tip sharp angle of 90 degree.
